(19) United States
(12) Patent Application Publication
(10) Pub. No.: US 2026/0360056 A1
(43) Pub. Date: Nov. 12, 2026

(54) Method and Apparatus for Displaying Dynamic Content, Device, Medium, and Program Product

(71) Applicant: Tencent Technology (Shenzhen) Company Limited, Shenzhen (CN)

(72) Inventors: Xinjian Qin, Shenzhen (CN); Shuo Shan, Shenzhen (CN)

(21) Appl. No.: 19/727,056

(22) Filed: Jul. 1, 2026

Related U.S. Application Data
(63) Continuation of application No. PCT/CN2025/108700, filed on Jul. 15, 2025.

(30) Foreign Application Priority Data
Aug. 29, 2024 (CN) 2024112079910

(51) Int. Cl. G06T 13/00; A63F 13/211; G06F 3/0338

(52) U.S. Cl. CPC G06T 13/00; A63F 13/211; G06F 3/0338

(57) ABSTRACT

A method and an apparatus for displaying dynamic content, a device, a medium, and a program product. The method comprises displaying dynamic content comprising at least two images and receiving a motion control operation on a terminal device. The method further comprises switching display between the at least two images in response to the motion control operation forming an animation in which the dynamic content changes.

### RELATED APPLICATIONS

This application is continuation application of PCT/CN2025/108700, filed on Jul. 15, 2025, which claims priority to Chinese Patent Application No. 202411207991.0, entitled “METHOD AND APPARATUS FOR DISPLAYING DYNAMIC CONTENT, DEVICE, MEDIUM, AND PROGRAM PRODUCT” and filed on Aug. 29, 2024, each of which is incorporated herein by reference in its entirety.

### FIELD OF THE TECHNOLOGY

This application relate to the technical field of computers, and in particular, to a method and an apparatus for displaying dynamic content, a device, a medium, and a program product.

### BACKGROUND OF THE DISCLOSURE

A gyroscope in a mobile phone may be referred to as an angular velocity sensor, is usually located on a main board of the mobile phone, and can acquire a current rotation state of the mobile phone. A dynamic display effect on a screen of the mobile phone can be achieved by using the gyroscope.

In the related art, a plurality of image layers are disposed in a screen of a mobile phone. When a user shakes the mobile phone, the plurality of image layers in the screen of the mobile phone may undergo location offsets based on angular velocity data collected by a gyroscope, to achieve a visual depth-enhanced space dynamic effect.

However, a method for controlling the location offset of the image layers by using the gyroscope to achieve a dynamic effect is relatively monotonous, which limits diversity of the dynamic effect.

### SUMMARY

This application provides a method and an apparatus for displaying dynamic content, a device, a medium, and a program product, which can enrich the diversity of dynamic effects. Technical solutions are as follows:

In an aspect, a method for displaying dynamic content is provided. The method is performed by a terminal device. The method comprises: displaying the dynamic content comprising at least two images; receiving a motion control operation on the terminal device; and switching display between the at least two images in response to the motion control operation, forming an animation in which the dynamic content changes.

In another aspect, an apparatus for displaying dynamic content. The apparatus includes: a first display module, configured to display the dynamic content, the dynamic content including at least two images; an operation receiving module, configured to receive a motion control operation on a terminal device; and a second display module, configured to switch display between the at least two images in response to the motion control operation, forming an animation in which the dynamic content changes.

In another aspect, a computer device is provided, including a processor and a memory, the memory having at least one instruction, at least one program, a code set, or an instruction set stored therein, and the at least one instruction, the at least one program, the code set, or the instruction set being loaded and executed by the processor to implement any one of the foregoing methods for displaying dynamic content.

In another aspect, a non-transitory computer-readable storage medium is provided, the storage medium having at least one instruction, at least one program, a code set, or an instruction set stored therein, and the at least one instruction, the at least one program, the code set, or the instruction set being loaded and executed by a processor to implement any one of the foregoing methods for displaying dynamic content.

In another aspect, a computer program product or a computer program is provided. The computer program product or the computer program includes a computer instruction. The computer instruction is stored in a computer-readable storage medium. A processor of a computer device reads the computer instructions from the computer-readable storage medium and executes the computer instructions, to enable the computer device to perform any one of the foregoing methods for displaying dynamic content.

The technical solutions provided in examples of this application achieve at least the following beneficial effects:

The dynamic content including at least two images is displayed in the terminal device. When a user controls the terminal device to move, display is switched between the at least two images in response to a user operation, to form an animation in which the dynamic content changes along with motion of the terminal device. In an aspect, the user may customize the design of the at least two images based on a requirement. Compared with a single image layer offset animation formed by an image layer offset, the dynamic content formed by switching display between the at least two images is richer, and diversity of the dynamic content formed by controlling the terminal device to move is enriched. In another aspect, the user can control, by using motion of the user, a display progress of the dynamic content displayed by the terminal device through user movements, to enhance interactivity between the user and the dynamic content, and improve human-computer interaction efficiency. In yet another aspect, because a dynamic visual effect of the dynamic content is implemented by switching display between at least two images, the terminal device can implement dynamic and diversified dynamic content by using only the at least two images provided in advance. In a process of presenting the dynamic content, consumption of computational resources of the terminal device is relatively small, and computational load on a device processor is relatively low. This enables the terminal device to operate at relatively low power consumption when rendering the dynamic content, and prolongs a battery duration of the terminal device.

### BRIEF DESCRIPTION OF THE DRAWINGS

FIG. 1 is a schematic diagram of a computer system according to an example of this application;

FIG. 2 is a schematic diagram of a method for displaying dynamic content according to an example of this application;

FIG. 3 is a flowchart of a method for displaying dynamic content according to an example of this application;

FIG. 4 is a flowchart of a method for displaying dynamic content according to another example of this application;

FIG. 5 is a schematic diagram of switching display images on a dynamic playback axis according to an example of this application;

FIG. 6 is a flowchart of a method for displaying dynamic content according to yet another example of this application;

FIG. 7 is a schematic diagram of switching display of images in a dynamic playback coordinate system according to an example of this application;

FIG. 8 is a flowchart of a method for displaying dynamic content according to an example of this application;

FIG. 9 is a schematic diagram of a functional framework of a gyroscope according to an example of this application;

FIG. 10 is a schematic diagram of effect production according to an example of this application; and

FIG. 11 is a schematic diagram of performance optimization according to an example of this application;

FIG. 12 is a structural block diagram of an apparatus for displaying dynamic content according to an example of this application; and

FIG. 13 is a structural block diagram of a computer device according to an example of this application.

### DESCRIPTION OF EMBODIMENTS

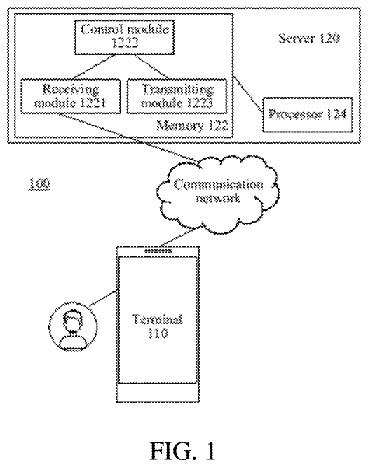

FIG. 1 is a structural block diagram of a computer system 100 according to an example of this application. The computer system 100 may be implemented as a system architecture of a method for displaying dynamic content. The computer system 100 includes: a terminal 110 and a server 120.

The terminal 110 may be an electronic device such as a mobile phone, a tablet computer, an in-vehicle terminal (an on board unit), a wearable device, a personal computer (PC), or an extended reality (XR) device (for example, a virtual reality (VR) head-mounted display). A client running a target application may be installed in the terminal 110. The target application may be any one of a VR program, an augmented reality (AR) program, a three-dimensional map program, a VR game, an AR game, a first-person shooting (FPS) game, a third-person shooting (TPS) game, a multiplayer online battle arena (MOBA) game, and a simulation game (SLG), a party game, a construction game, open-world game, a survival character-playing game, and the like. In addition, this application does not limit a form of the target application, including, but not limited to, an application (App), an applet, and the like installed on the terminal 110, and may alternatively be a form of a web page.

The terminal 110 is connected to the server 120 through a wireless network or a wired network.

The server 120 can be an independent physical server, a server cluster or a distributed system including a plurality of physical servers, or a cloud server providing a cloud computing service. In some examples, the server 120 may alternatively be implemented as a node in a blockchain system.

For example, the server 120 includes a processor 124 and a memory 122. The memory 122 further includes a receiving module 1221, a control module 1222, and a transmitting module 1223. The receiving module 1221 is configured to receive a request transmitted by the terminal 110. The control module 1222 is configured to control rendering of a virtual world picture. The transmitting module 1223 is configured to transmit a response to the terminal 110. The server 120 is configured to provide a back-end service for the terminal 110.

In some examples, the server 120 is responsible for primary computing work, and the terminal 110 is responsible for secondary computing work; alternatively, the server 120 is responsible for secondary computing work, and the terminal 110 is responsible for primary computing work; alternatively, the server 120 and the terminal 110 perform collaborative computing by using a distributed computing architecture.

Operations of a method for displaying dynamic content according to this example of this application may be performed by a computer device. The computer device refers to an electronic device having data computation, processing, and storage capabilities. A computer system shown in FIG. 1 is used as an example. The terminal 110 may perform the method for displaying dynamic content (for example, the target application that is installed and runs in the terminal 110 performs the method for displaying dynamic content), or the server 120 may perform the method for displaying dynamic content, or the terminal 110 and the server 120 interact and cooperate to perform the method. This is not limited in this application.

A person skilled in the art can learn that more or fewer terminals 110 can be provided. For example, there may be only one terminal 110, or there may be dozens or hundreds, or even more terminals 110. This example of this application does not limit a quantity or device types of the terminals 110.

A gyroscope in a mobile phone may be referred to as an angular velocity sensor, is usually located on a main board of the mobile phone, and can acquire a current rotation state of the mobile phone. A dynamic display effect on a screen of the mobile phone can be achieved by using the gyroscope. In the related art, a plurality of image layers are disposed in a screen of a mobile phone. When a user shakes the mobile phone, the plurality of image layers in the screen of the mobile phone may undergo positional offsets based on angular velocity data collected by a gyroscope, to achieve a spatial dynamic effect of front-to-back visual layering and enhanced visual depth. However, a method for controlling the location offset of the image layers by using the gyroscope to achieve a dynamic effect is relatively monotonous, which limits diversity of the dynamic effect.

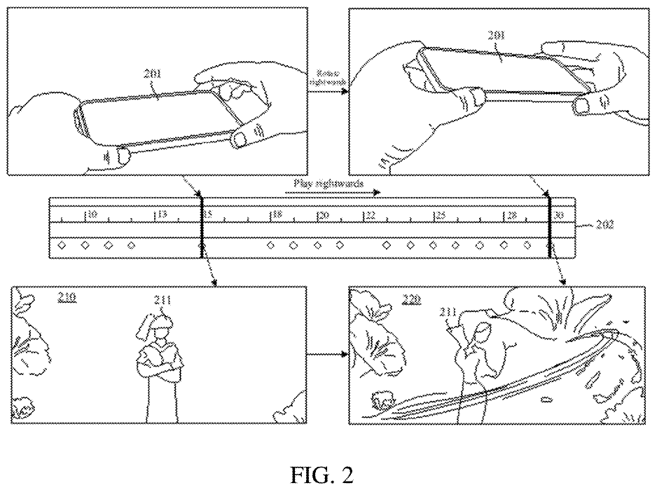

This application provides a method for displaying dynamic content. An example in which dynamic content is implemented as an animation is used. FIG. 2 is a schematic diagram of a method for displaying dynamic content according to an example of this application. An example in which the method is applied to a computer device is used for description. The computer device may be the terminal 110 shown in FIG. 1.

According to the method for displaying dynamic content provided in this application, an animation may be produced in a virtual engine. The animation includes at least two images, and the at least two images are distributed in an animation timeline. When a user controls a motion of a mobile phone, at least two images are switched and displayed on the animation timeline based on a motion direction and speed of the mobile phone, to control a playback effect of the animation.

Referring to FIG. 2, when a mobile phone 201 is placed flat and remains stationary, an image 210 in a center of an animation timeline 202 is displayed on an interface of the mobile phone 201. A character 211 in the image 210 is in a standing state, no ink wash special effect is present in the image 210, and some flowers are in a semi-blooming state. When the user controls the mobile phone 201 to rotate rightwards, images on the animation timeline are sequentially displayed rightwards, to be specific, the animation is played rightwards along the animation timeline by using the image 210 as a starting frame. In addition, a playback speed of the animation is determined by a magnitude of the rotation of the mobile phone 201 controlled by the user. For example, a higher playback speed of the animation is achieved as the user increases the magnitude of the rotation of the mobile phone 201.

In a process in which the user controls the mobile phone 201 to rotate rightwards, the interface of the mobile phone 201 plays animations of character dancing, ink wash appearing, and flowers slowly blooming. When a rightward rotation angle of the mobile phone 201 controlled by the user reaches a preset angle, an image 220 on the rightmost of the animation timeline 202 is displayed on the interface of the mobile phone 201. In the animation timeline 202, a character 211 is in a dancing state, an ink wash special effect is presented, and flowers are in a blooming state.

According to the method for displaying dynamic content provided in this example of this application, motion of a mobile phone is combined with an engine animation, and a user may control an animation playback progress by controlling the mobile phone, to present different effects, improve richness and an interactivity of the dynamic content, and improve human-computer interaction efficiency.

Next, a procedure of the method for displaying dynamic content according to this application is described.

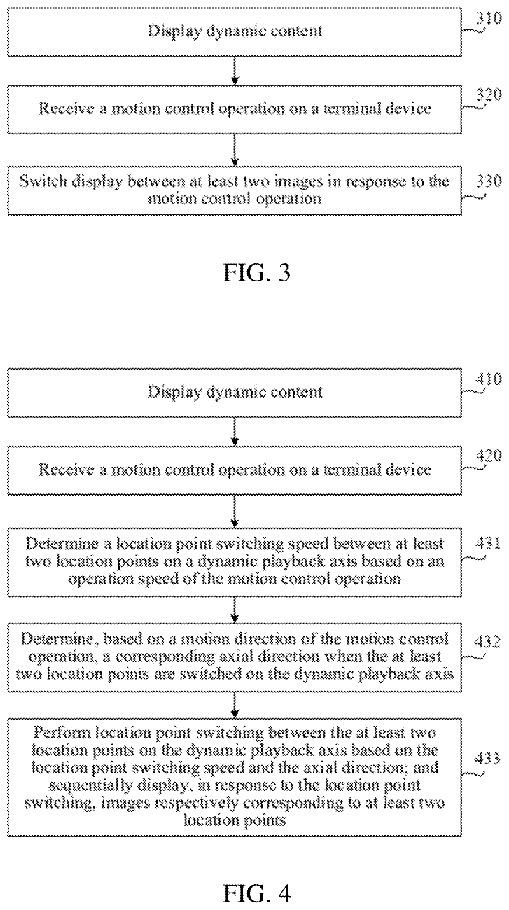

FIG. 3 is a flowchart of a method for displaying dynamic content according to an example of this application. An example in which the method is applied to a terminal device is used for description. The terminal device may be the terminal 110 shown in FIG. 1, and the method includes operation 310 to operation 330.
Operation 310: Display dynamic content.

In some examples, types of the dynamic content include an animation, a video, an animated image, and the like. For example, the dynamic content may be character introduction content, dynamic wallpaper, a lock screen animation, a song cover, and the like. This is not limited herein.

The dynamic content includes at least two images, and the at least two images are configured for representing dynamic presentation of the dynamic content. In some examples, the at least two images are arranged in preset order.

For example, at least two images are pre-configured, and a consecutive animation may be formed by playing the at least two images in preset order.

In some examples, when the dynamic content is displayed, a first image of the at least two images of the dynamic content is displayed.

In some examples, the first image may be any image of the at least two images. For example, the at least two images are images arranged in preset order, and when the terminal device remains stationary and is placed flat, an image that is arranged first in the at least two images is displayed as the first image; or an image that is arranged in the middle of the at least two images is displayed as the first image; or an image that is arranged last in the at least two images is displayed as the first image.

In some other examples, when the dynamic content is displayed, a default animation corresponding to the dynamic content is displayed.

In some examples, the default animation refers to a dynamic visual effect formed by sequentially displaying at least two images of the at least two images. For example, the at least two images are images arranged in preset order, and when the terminal device remains stationary and is placed flat, the first two images of the at least two images are sequentially displayed based on a preset speed to form a default animation; or the middle two images of the at least two images are sequentially displayed based on a preset speed to form a default animation; or the last two images of the at least two images are sequentially displayed based on a preset speed to form a default animation. In some examples, the dynamic content is a default animation that is circularly played.
Operation 320: Receive a motion control operation on a terminal device.

In some examples, the terminal device includes mobile devices such as a mobile phone, a tablet computer, and a wearable device. In some examples, the motion control operation on the terminal device includes moving the terminal device, rotating the terminal device, and the like. This is not limited herein.

In some examples, the terminal device includes an angular velocity sensor, and the angular velocity sensor can measure rates and directions of rotation of the terminal device about a plurality of axes (generally, X, Y, and Z axes). The angular velocity sensor may be implemented as a gyroscope.

In some examples, the terminal device is connected to a game controller device. In some examples, the terminal device is connected to the game controller device in a wired or wireless (such as Bluetooth) manner.

In some examples, a motion control operation on the game controller device is received as a motion control operation on the terminal device. In some examples, the motion control operation on the game controller device includes moving the game controller device, rotating the game controller device, and the like. This is not limited herein. The game controller device includes an angular velocity sensor, and the angular velocity sensor may be implemented as a gyroscope.

In the foregoing examples, the game controller device is connected to the terminal device, and a user can freely move within a particular range, to provide rich user interaction experience, and enhance accuracy and flexibility of motion control.
Operation 330: Switch display between at least two images in response to the motion control operation.

Switching between the at least two images represents that the dynamic content changes in response to the motion control operation.

For example, when the user controls the terminal to move, the terminal device switches display between the at least two images. For example, the at least two images are images arranged in preset order, an image a is located in the middle of the at least two images, and the image a is currently displayed. When the user rotates the terminal device leftwards, the terminal device sequentially displays images previous to the image a by using the image a as a starting frame, and a reverse animation may be formed. When the user rotates the terminal device rightwards, the terminal device sequentially displays images subsequent to the image a by using the image a as a starting frame, and a forward animation may be formed. Alternatively, when the user rotates the terminal device upwards, the terminal device sequentially displays images previous to the image a by using the image a as a starting frame, and a reverse animation may be formed; and when the user rotates the terminal device downwards, the terminal device sequentially displays images subsequent to the image a by using the image a as a starting frame, and a forward animation may be formed.

In some examples, display is switched, based on an operation speed of the motion control operation and a motion direction of the motion control operation, between the at least two images in response to the motion control operation.

In some examples, the operation speed of the motion control operation is in a positive correlation with a switching speed at which display is switched between the at least two images. A higher operation speed of the motion control operation indicates a higher switching speed. In some examples, the motion direction of the motion control operation is configured for determining a switching direction in which display is switched between at least two images. For example, the at least two images are arranged in preset order, when the user controls the terminal device to rotate leftwards or upwards, the switching direction of the at least two images is the preset order, and when the user controls the terminal device to rotate rightwards or downwards, the switching direction of the at least two images is a direction opposite to the preset order. Examples of a correspondence between the motion direction and the switching direction herein are merely schematic descriptions. This is not limited herein.

In some examples, the terminal device includes an angular velocity sensor. In some examples, angular velocity data collected by the angular velocity sensor is acquired; and based on the angular velocity data, display is switched between the at least two images in response to the motion control operation.

For example, when the user moves or rotates the terminal device, the angular velocity sensor captures and records angular velocities of a mobile device in real time. The angular velocities are represented in a vector form and respectively correspond to angular velocities of the terminal device about different axes (for example, an X axis, a Y axis, and a Z axis).

In some examples, an operation speed of the motion control operation and a motion direction of the motion control operation are determined based on the angular velocity data, and based on the operation speed of the motion control operation and the motion direction of the motion control operation, display is switched between the at least two images in response to the motion control operation.

In some examples, the angular velocity data includes at least one of angular velocities about the X axis, the Y axis, and the Z axis.

For example, data magnitude of the angular velocity data is acquired, and the operation speed (e.g., the operation speed herein refers to a meaning of speed magnitude) of the motion control operation is determined based on the data magnitude; and a vector direction of the angular velocity data is acquired, and the motion direction of the motion control operation is determined based on the vector direction.

In the foregoing examples, the angular velocity data is acquired and analyzed, to precisely identify the motion control operation of the user, and improve accuracy in controlling the animation that is represented by the dynamic content in response to the motion control operation.

In some examples, the angular velocity sensor is activated in a case that an animation mode of the dynamic content is in an enabled state; and the angular velocity sensor is deactivated in a case that the animation mode of the dynamic content is in a hidden state or a disabled state. That is, whether the angular velocity sensor needs to be activated is determined based on the enabled or disabled state of the animation mode of the dynamic content. In this way, the angular velocity sensor is not enabled when a dynamic effect of the dynamic content does not need to be presented, and power consumption when the terminal device runs electronic components is reduced.

For example, when the terminal device has an animation mode in the enabled state, a gyroscope switch of a mobile device is turned on. When the terminal device does not have an animation mode in the enabled state, that is, all animation modes are in the hidden state or the disabled state, the gyroscope switch of the mobile device is turned off, to minimize time for activating a gyroscope function, and reduce performance overhead of the device.

In some examples, a trajectory drawing operation is received, the trajectory drawing operation being configured for controlling the terminal device to move to form a first motion trajectory; and in a case that the first motion trajectory meets a preset trajectory requirement, it is determined that the animation mode of the dynamic content is in the enabled state, and the angular velocity sensor is activated.

For example, based on the trajectory drawing operation of the user, the terminal device moves according to a drawn path, to form the first motion trajectory. The preset trajectory may be any predefined path or shape, configured for verifying whether the trajectory drawn by the user is accurate. When the first motion trajectory meets the preset trajectory requirement, it is determined that the animation mode of the dynamic content is in the enabled state. This means that the user has successfully triggered an animation visual effect of the dynamic content via the trajectory drawing operation. After it is determined that the animation mode is enabled, the angular velocity sensor is activated.

In the foregoing examples, the animation visual effect of the dynamic content is triggered only when the trajectory drawn by the user meets the preset requirement. This ensures accuracy and intention definition of operations of the user, avoids unnecessary energy consumption, and ensures that the sensor works only when needed.

In some examples, the at least two images include images distributed on a dynamic playback axis, and different images correspond to different location points on the dynamic playback axis.

In some examples, location point switching is performed between the at least two location points on the dynamic playback axis based on a motion control operation; and images respectively corresponding to the at least two location points are sequentially displayed in response to the location point switching, to form an animation in which dynamic content changes in response to the motion control operation.

The location point switching refers to selecting a target location point corresponding to a current moment from the at least two location points based on the motion control operation. The target location point is selected based on location distribution of the at least two location points on the dynamic playback axis, and the selected target location point determines an image displayed at the current moment. That is, with execution of the motion control operation, the at least two location points on the dynamic playback axis are selected as the target location point in turn. This process is referred to as the location point switching.

Using a lock screen animation as an example, at least two location points are set on a dynamic playback axis corresponding to the lock screen animation, and each location point corresponds to a particular phase in a flower growth process. Images are set at the at least two location points in order, and at least two images describe a whole process in which a flower starts to gradually expand petals from an initial tightly closed flower bract state until the flower finally completely bloomed. When the terminal device does not receive a motion control operation, a flower image in a tightly closed flower bract state at a start location point is displayed, and when a user controls the terminal device to rotate leftwards, rightwards, upwards, or downwards, flower images at location points after the start location point are sequentially displayed, to control a playback progress of a flowering animation of a flower in the flower image based on a rotation operation of the user on the terminal device. In some examples, when the terminal device displays a flower image in a blooming state at a termination location point in response to the motion control operation, the terminal device is unlocked.

Using a song cover as an example, a dynamic playback axis corresponding to the song cover may be implemented as a playback axis of a song. A plurality of time points are set on the song playback axis, cover images are set at the plurality of time points in order, and the plurality of cover images describe a particular highlight in a music video (MV) of the song. When the terminal device does not receive a motion control operation, the cover image at a start time point is displayed, and when the user controls the terminal device to rotate leftwards, rightwards, upwards, or downwards, the cover images at the time points after the start time point are sequentially displayed, to control a playback progress of the highlight in the song cover based on a rotation operation of the user on the terminal device. In some examples, at a termination of the motion control operation, a target time point corresponding to the termination of the operation is acquired, and the song starts to be played from the target time point.

Different location points are set on the dynamic playback axis, and different images are set for the different location points. In this way, an animation displayed by a terminal device in a motion process can present a content change from a time dimension, displayed dynamic content has a visual effect of a time change, and diversity of display of the dynamic content is improved.

The foregoing examples are only schematic descriptions. This is not limited in this application.

In some examples, the at least two images include images distributed in a dynamic playback coordinate system, and different images correspond to different coordinate points in the dynamic playback coordinate system.

Coordinate point switching is performed between the at least two coordinate points in a dynamic playback coordinate system based on the motion control operation; and images respectively corresponding to the at least two coordinate points are sequentially displayed in response to the coordinate point switching, to form an animation in which dynamic content changes in response to the motion control operation.

The coordinate point switching refers to selecting a target coordinate point corresponding to a current moment from the at least two coordinate points based on the motion control operation. The target coordinate point is selected based on location distribution of the at least two coordinate points on the dynamic playback coordinate system, and the selected target coordinate point determines an image displayed at the current moment. That is, with execution of the motion control operation, the at least two coordinate points in the dynamic playback coordinate system are selected as the target coordinate point in turn. This process is referred to as the coordinate point switching.

Different coordinate points are set in the dynamic playback coordinate system, and different images are set for the different coordinate points. In this way, an animation displayed by a terminal device in a motion process can present a content-changing effect of multiple content objects intersecting across different time dimensions, displayed dynamic content has a visual effect of a time change, and diversity of display of the dynamic content is improved.

In some examples, the dynamic playback coordinate system refers to a rectangular plane coordinate system, and the dynamic playback coordinate system includes a first playback axis and a second playback axis that are perpendicular to each other.

For example, a plurality of first image layers are configured at a plurality of first coordinate points on the first playback axis, a plurality of second image layers are configured at a plurality of second coordinate points on the second playback axis, the first image layers and the second image layers are superposed to form a target image, the plurality of first image layers are configured for describing a flowering process of a flower, and the plurality of second image layers are configured for describing a dancing process of a virtual character. When a user controls the terminal device to rotate leftwards or rightwards, coordinate point switching is performed among the plurality of first coordinate points, and a flowering animation of the flower is displayed on a terminal interface. When the user controls the terminal device to rotate upwards or downwards, coordinate point switching is performed among the plurality of second coordinate points, and the terminal interface displays a dancing animation of the virtual character.

When the user controls the terminal device to rotate leftwards or rightwards by an angle and to stop rotating, a flower image at a coordinate point indicated by a current rotation control operation is displayed. For example, a flower image in a semi-blooming state is displayed. In this case, the user maintains an angle of rotating leftwards or rightwards, and controls the terminal device to rotate upwards or downwards, and then the dancing animation of the virtual character under a background of a flower in the semi-blooming state is displayed.

In some examples, the image includes image layers respectively corresponding to m elements, the dynamic content includes m pieces of sub-dynamic content, a j^{th} piece of sub-dynamic content indicates a change process of a j^{th} piece of display element, m is an integer greater than 1, j≤m, and j is a positive integer.

In some examples, switching display between the at least two images in response to the motion control operation, switching between the at least two j^{th} images representing that the j^{th} sub-dynamic content changes in response to the motion control operation.

For example, the image is decomposed into m image layers, each image layer corresponds to a display element (or a group of related elements), and these display elements may be any component in the image, such as a background, a foreground object, or a virtual character. That is, the dynamic content includes a plurality of animations, such as a background animation, a foreground animation, and a character animation, control relationships between the plurality of animations and the motion control operation may be independent of each other. That is, a finally presented animation of the dynamic content is a compound animation including the background animation, the foreground animation, the character animation, and the like.

In some examples, the m pieces of sub-dynamic content are displayed on the m image layers, where a j^{th} image layer is configured to display a j^{th} piece of sub-dynamic content layer; and in response to the motion control operation, the m image layers are moved based on different motion policies and display is switched between the at least two images in the m image layers, where the j^{th} image layer is configured to switch display between the j^{th} image layers respectively corresponding to the at least two images.

For example, each image layer carries specific visual information, that is, a piece of sub-dynamic content. For example, the foreground image layer displays the foreground animation, a middle ground image layer displays the character animation, and a background image layer displays the background animation. Motion policies of different image layers may be different in response to the motion control operation. For example, when a user controls a terminal device to rotate rightwards, the background image layer remains stationary, the middle ground image layer moves rightwards, and the foreground image layer moves leftwards. The motion policies are not limited herein.

In the foregoing examples, dynamic content of different display elements is presented in layers, and the user is allowed to perform fine control on image layers at an image layer level and a content level, to present richer compound animation finally.

In some examples, progress information corresponding to the dynamic content is displayed, the progress information indicating a playback progress of the dynamic content; and progress information is updated based on a currently displayed image in response to a motion control operation.

In some examples, when the at least two images include images distributed on a dynamic playback axis, a progress bar is displayed as the progress information. For example, the progress bar is usually a horizontal or vertical long bar, and a length of the progress bar represents playback duration or progress of entire dynamic content. On the progress bar, there is a slide element that moves with playback of the dynamic content, and a current location of the slide element indicates a location point indicated by a current motion control operation, that is, a location of a currently played image on the dynamic playback axis.

In some examples, when the at least two images include images distributed in a dynamic playback coordinate system, a progress region is displayed as the progress information. For example, the progress region is a rectangular region or another shape. This is not limited herein. A progress indication identifier (for example, an identifier point) is displayed in the progress region, and a real-time location of the progress indication identifier in the progress region indicates a location of a currently played image in the dynamic playback coordinate system.

In the foregoing examples, the progress information corresponding to the dynamic content is displayed, whereby a user can intuitively learn a playback progress of the dynamic content, and adjust and display a current playback state via the motion control operation, user experience is enhanced, and human-computer interaction efficiency is improved.

In conclusion, according to the method for displaying dynamic content provided in this example of this application, dynamic content including at least two images is displayed in the terminal device. When a user controls the terminal device to move, display is switched between the at least two images in response to a user operation, to form an animation in which the dynamic content changes along with the motion of the terminal device. In an aspect, the user may customize the design of the at least two images based on a requirement. Compared with a single image layer offset animation formed by an image layer offset, the dynamic content formed by switching display between the at least two images is richer, and diversity of the dynamic content formed by controlling the terminal device to move is enriched. In another aspect, the user can control a display progress of the dynamic content displayed by the terminal device through user movements, to enhance interactivity between the user and the dynamic content, and improve human-computer interaction efficiency. In yet another aspect, because a dynamic visual effect of the dynamic content is implemented by switching display between at least two images, the terminal device can implement dynamic and diversified dynamic content by using only the at least two images provided in advance. In a process of presenting the dynamic content, consumption of computational resources of the terminal device is relatively small, and computational load on a device processor is relatively low. This enables the terminal device to operate at relatively low power consumption when rendering the dynamic content, and prolongs battery duration of the terminal device.

In some examples, the at least two images are implemented as images distributed on a dynamic playback axis. For example, as shown in FIG. 4, the example shown in FIG. 3 may alternatively be implemented as the following operation 410 to operation 433.
Operation 410: Display dynamic content.

The dynamic content includes at least two images, and the at least two images are configured for representing dynamic presentation of the dynamic content.

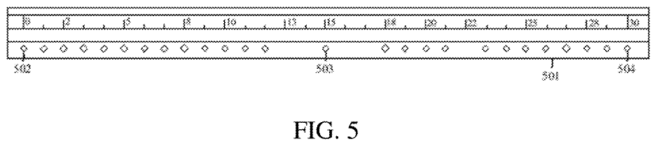

The at least two images are images distributed on a dynamic playback axis, and different images correspond to different location points on the dynamic playback axis. For example, FIG. 5 is a schematic diagram of a dynamic playback axis. At least two location points (rhombus marks) are distributed on the dynamic playback axis 501, and an image may be configured at each location point.

In some examples, when the terminal device is in a preset state, and when dynamic content is displayed, an image at a default location point of the at least two location points is displayed.

The default location point may be any one of the at least two location points. For example, referring to FIG. 5, a start location point 502 is set as the default location point, an intermediate location point 503 is set as the default location point, or a termination location point 504 is set as the default location point.

In some examples, the preset state refers to a state in which the terminal device remains stationary and is placed flat when not receiving a motion control operation, or the preset state may be a user-defined state. This is not limited herein.
Operation 420: Receive a motion control operation on a terminal device.

In some examples, angular velocity data corresponding to the motion control operation is acquired, the angular velocity data being configured for indicating an angular velocity that is generated relative to a reference plane when the terminal device is controlled to move via the motion control operation.

For example, the terminal device includes an angular velocity sensor, and the angular velocity sensor can measure angular velocities of the terminal device about a plurality of axes (generally, X, Y, and Z axes). The angular velocity sensor may be implemented as a gyroscope.

In some examples, the angular velocity data includes at least one of angular velocities about the X axis, the Y axis, and the Z axis. For example, the angular velocity data is a vector, including angular velocities of the terminal device on axes (generally, X, Y, and Z axes), and the vector may be represented by using three components, respectively corresponding to the angular velocities on the three axes.

In some examples, an operation speed of the motion control operation is determined based on data magnitude of the angular velocity data.

For example, angular velocities about an X axis, a Y axis, and a Z axis are respectively acquired by using a gyroscope, to obtain a three-dimensional vector, denoted as an angular velocity vector w. A modulus of the angular velocity vector w is calculated as the data magnitude of angular velocity data. Alternatively, a vector g in a gravity direction is acquired by using an accelerometer, and angular velocities respectively about an X axis, a Y axis, and a Z axis are acquired by using a gyroscope, to obtain a three-dimensional vector, denoted as an angular velocity vector. A dot product g·w of the vector g and the angular velocity vector w is calculated, an angular velocity component w_{g} of the angular velocity vector w in the gravity direction is calculated by using the dot product g·w, an angular velocity component w−w_{g} that excludes the gravity direction is calculated, where w−w_{g} is an unbiased angular velocity perpendicular to the gravity direction, and a modulus of the unbiased angular velocity is calculated as the data magnitude of the angular velocity data.

A larger modulus indicates faster rotation of the device. A smaller modulus indicates a slower rotation of the device.

In some examples, the motion direction of the motion control operation is determined based on a vector direction of the angular velocity data.

For example, a rotation axis corresponding to a component having a maximum absolute value in the angular velocity data is determined as a main rotation axis. If a component corresponding to the X axis has a maximum absolute value, the main rotation axis is the X axis; if a component corresponding to the Y axis has a maximum absolute value, the main rotation axis is the Y axis; and if a component corresponding to the Z axis has a maximum absolute value, the main rotation axis is the Z axis. After the main rotation axis is determined, the motion direction of the motion control operation is determined based on a rotation direction of the main rotation axis. For example, if the rotation direction of the main rotation axis is anticlockwise, the motion direction is a first direction, and if the rotation direction of the main rotation axis is clockwise, the motion direction is a second direction.

In some examples, when the main rotation axis is determined as the X axis, a modulus of an angular velocity of rotation of the gyroscope about the X axis may be acquired as the data magnitude of the angular velocity data. When the main rotation axis is determined as the Y axis, a modulus of an angular velocity of rotation of the gyroscope about the Y axis may be acquired as the data magnitude of the angular velocity data. When the main rotation axis is determined as the Z axis, a modulus of an angular velocity of rotation of the gyroscope about the Z axis may be acquired as the data magnitude of angular velocity data.
Operation 431: Determine a location point switching speed between at least two location points on a dynamic playback axis based on an operation speed of the motion control operation.

In some examples, the operation speed of the motion control operation is in a positive correlation with the location point switching speed between the at least two location points. That is, a higher speed at which the user performs the motion control operation indicates a corresponding higher switching speed between location points. Otherwise, if the operation speed is low, the switching speed between the location points is slowed.

In some examples, speed mapping data of the dynamic playback axis is acquired, where the speed mapping data is configured for indicating a mapping relationship between the operation speed and the location point switching speed. The operation speed is mapped based on the speed mapping data to obtain the location point switching speed between the at least two location points on the dynamic playback axis.

For example, the speed mapping data may be a predefined table, function, or algorithm, and the corresponding switching speed is calculated based on the operation speed.

In some examples, the dynamic playback axis includes a plurality of axis segments.

In some examples, different axis segments correspond to different speed mapping data.

In some examples, in a case that the motion direction of the motion control operation matches an i^{th} axis segment, speed mapping data of the i^{th} axis segment is acquired, the speed mapping data being configured for indicating a mapping relationship between the operation speed and the location point switching speed, and i being a positive integer; and the operation speed is mapped based on the speed mapping data, to obtain an i^{th} location point switching speed between at least two location points on the i^{th} axis segment.

That the motion direction of the motion control operation matches the i^{th} axis segment means that an axial direction determined based on the motion direction of the motion control operation includes the i^{th} axis segment. For example, a current terminal device displays an image corresponding to a location point 1, and when a user controls the terminal device to rotate rightwards, location point switching is performed between at least two location points on an axis on a right side of the location point 1. If the axis on the right side of the location point 1 includes the i^{th} axis segment, it indicates that the motion direction of the motion control operation matches the i^{th} axis segment.

For example, it is assumed that the dynamic playback axis is divided into two axis segments: A and B, and each axis segment corresponds to a different dynamic presentation. For example, the axis segment A corresponds to a first phase of the flowering animation in the dynamic content, and the axis segment B corresponds to a second phase of the flowering animation in the dynamic content. When the user controls the terminal device to rotate, and when the motion direction of the motion control operation matches the axis segment A, the first phase of the flowering animation in the dynamic content is displayed. When the motion direction of the motion control operation matches the axis segment B, the second phase of the flowering animation in the dynamic content is displayed.

Speed mapping data is predefined for each axis segment. For example, speed mapping of the axis segment A may be linear, and speed mapping of the axis segment B may be non-linear. When the user browses the axis segment A, a rotation speed at which the terminal device rotates proportionally affects a playback speed of the flowering animation. However, when the axis segment B is browsed, the flowering animation may be played slowly at the beginning, but when a rotation speed at which the terminal device rotates increases and reaches a particular threshold, the flowering animation suddenly accelerates to be played.

In the foregoing examples, the dynamic playback axis includes a plurality of axis segments, and the user may control a playback speed and effect of the animation by controlling the terminal device. Different axis segments have different speed mapping data, diversity of the animation formed by controlling the terminal to move is enriched, and the user can experience different control effects at different playback phases of the dynamic content.
Operation 432: Determine, based on a motion direction of the motion control operation, a corresponding axial direction when the at least two location points are switched on the dynamic playback axis.

In some examples, the dynamic playback axis correspondingly has a first axial direction and a second axial direction, and the first axial direction is opposite to the second axial direction.

In some examples, in a case that the motion direction of the motion control operation meets a first direction requirement, the corresponding axial direction when the at least two location points are switched on the dynamic playback axis is determined as the first axial direction; and in a case that the motion direction of the motion control operation meets a second direction requirement, the corresponding axial direction when the at least two location points are switched on the dynamic playback axis is determined as the second axial direction.

For example, if the rotation direction of the main rotation axis is anticlockwise, the motion direction is the first direction, that is, the first direction requirement is met, and the corresponding axial direction when the at least two location points are switched on the dynamic playback axis is determined as the first axial direction; and if the rotation direction of the main rotation axis is clockwise, the motion direction is the second direction, that is, a second direction requirement is met, and the corresponding axial direction when the at least two location points on the dynamic playback axis is determined as the second axial direction.
Operation 433: Perform location point switching between the at least two location points on the dynamic playback axis based on the location point switching speed and the axial direction; and sequentially display, in response to the location point switching, images respectively corresponding to at least two location points.

For example, switching is performed between the at least two location points on the dynamic playback axis based on the location point switching speed and the axial direction that are determined previously, and the images corresponding to the location points are sequentially displayed with the location point switching, to form the animation of the dynamic content.

In the foregoing examples, the switching speed and the axial direction of the location point are determined based on the motion control operation of the user, and the user is allowed to affect location point switching on the dynamic playback axis in real time via the motion control operation. This instant feedback mechanism enhances interactivity of a system, and enables the user to better control a playback process. In addition, the switching speed and the axial direction of the location point are accurately controlled, to enable more effective resource utilization, avoid unnecessary calculation or rendering, and improve overall performance.

In conclusion, according to the method for displaying dynamic content provided in this example of this application, dynamic content including a plurality of images is displayed in the terminal. The plurality of images are images distributed on the dynamic playback axis. When the user controls the terminal to move, display of the plurality of images on the dynamic playback axis is switched in response to a user operation, to form an animation in which the dynamic content changes along with motion of the terminal. In an aspect, the user may customize the design of the plurality of images based on a requirement. Compared with a single image layer offset animation formed by an image layer offset, the animation formed by switching display between the plurality of images is richer, and diversity of the animation formed by controlling the terminal to move is enriched. According to another aspect, the plurality of images are distributed on the dynamic playback axis, and the user can intuitively understand a correspondence between different images and location points on the playback axis, to directly control a playback progress of the animation and display content via the motion control operation, and increase a sense of participation and a sense of control of the user. In yet another aspect, because a dynamic visual effect of the dynamic content is implemented by switching display between at least two images, the terminal device can implement dynamic and diversified dynamic content by using only the at least two images provided in advance. In a process of presenting the dynamic content, consumption of computational resources of the terminal device is relatively small, and computational load on a device processor is relatively low. This enables the terminal device to operate with relatively low power consumption when rendering the dynamic content, and prolongs battery duration of the terminal device.

In this example of this application, switching display between location points on the dynamic playback axis is controlled based on the operation speed and the motion direction of the motion control operation. When display of image content at different location points is switched, a dynamic effect trend (for example, a dynamic change speed and a dynamic change direction) of the image content can match the motion of the terminal device, to ensure matching between the dynamic effect and the terminal device from a visual effect, and improve a display effect of the dynamic content.

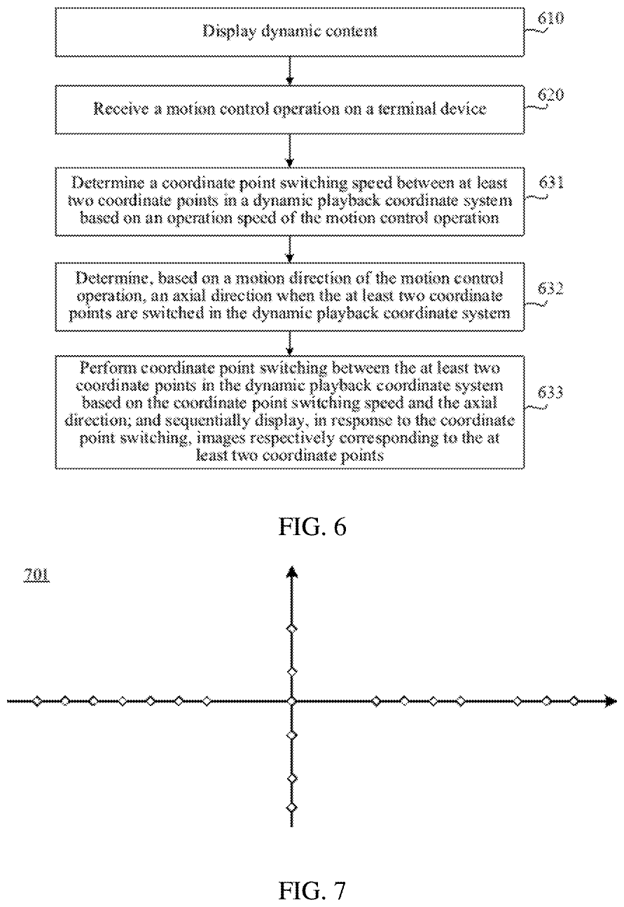

In some examples, the at least two images are implemented as images distributed in a dynamic playback coordinate system. For example, as shown in FIG. 6, the example shown in FIG. 3 may alternatively be implemented as the following operation 610 to operation 633.
Operation 610: Display dynamic content.

The dynamic content includes at least two images, and the at least two images are configured for representing dynamic presentation of the dynamic content.

The at least two images are images distributed in the dynamic playback coordinate system, and different images correspond to different coordinate points in the dynamic playback coordinate system.

In some examples, the dynamic playback coordinate system has a first playback axis and a second playback axis, the first playback axis corresponds to a first axial direction and a second axial direction, the first axial direction is opposite to the second axial direction, the second playback axis corresponds to a third axial direction and a fourth axial direction, and the third axial direction is opposite to the fourth axial direction.

In some examples, the dynamic playback coordinate system is a rectangular plane coordinate system, the first playback axis being perpendicular to the second playback axis. For example, images are configured only at coordinate points on the first playback axis and the second playback axis.

For example, FIG. 7 is a schematic diagram of a dynamic playback coordinate system. At least two coordinate points are distributed on a first playback axis and a second playback axis of the dynamic playback coordinate system 701, and an image may be configured at each coordinate point.

In some examples, when the terminal device is in a preset state, and when dynamic content is displayed, an image at a default coordinate point of the at least two coordinate points is displayed.

The default coordinate point may be any one of the at least two coordinate points. This is not limited herein.

In some examples, the preset state refers to a state in which the terminal device remains stationary and is placed flat when not receiving a motion control operation, or the preset state may be a user-defined state. This is not limited herein.
Operation 620: Receive a motion control operation on a terminal device.

In some examples, angular velocity data corresponding to the motion control operation is acquired, the angular velocity data being configured for indicating an angular velocity that is generated relative to a reference plane when the terminal device is controlled to move via the motion control operation.

In some examples, the terminal device includes an angular velocity sensor, and the angular velocity sensor can measure angular velocities of the terminal device about a plurality of axes (generally, X, Y, and Z axes). The angular velocity sensor may be implemented as a gyroscope.

In some examples, the angular velocity data includes at least one of angular velocities about the X axis, the Y axis, and the Z axis. For example, the angular velocity data is a vector, including angular velocities of the terminal device on axes (generally, X, Y, and Z axes), and the vector may be represented by using three components that respectively correspond to the angular velocities on the three axes.

In some examples, an operation speed of the motion control operation is determined based on data magnitude of the angular velocity data.

For example, angular velocities about an X axis, a Y axis, and a Z axis are respectively acquired by using a gyroscope, to obtain a three-dimensional vector, denoted as an angular velocity vector w. A modulus of the angular velocity vector w is calculated as the data magnitude of angular velocity data. Alternatively, a vector g in a gravity direction is acquired by using an accelerometer, and angular velocities respectively about an X axis, a Y axis, and a Z axis are acquired by using a gyroscope, to obtain a three-dimensional vector, denoted as an angular velocity vector. A dot product g·w of the vector g and the angular velocity vector w is calculated, an angular velocity component w_{g} of the angular velocity vector w in the gravity direction is calculated by using the dot product g·w, an angular velocity component w−w_{g} that excludes the gravity direction is calculated, where w−w_{g} is an unbiased angular velocity perpendicular to the gravity direction, and a modulus of the unbiased angular velocity is calculated as the data magnitude of the angular velocity data.

A larger modulus indicates faster rotation of the device. A smaller modulus indicates a slower rotation of the device.

In some examples, the motion direction of the motion control operation is determined based on a vector direction of the angular velocity data.

Before the motion direction is determined, a playback axis needs to be determined first, and then the motion direction of the motion control operation is determined. For example, if a component corresponding to the X axis is greater than a component corresponding to the Y axis, the playback axis is determined as a first playback axis. If a rotation direction of the X axis is anticlockwise, the motion direction is a first direction, and if the rotation direction of the X axis is clockwise, the motion direction is a second direction. If a component corresponding to the Y axis is greater than a component corresponding to the X axis, the playback axis is determined as a second playback axis. If a rotation direction of the Y axis is anticlockwise, the motion direction is a third direction, and if the rotation direction of the Y axis is clockwise, the motion direction is a fourth direction.

In some examples, if the component corresponding to the X axis is greater than the component corresponding to the Y axis, the playback axis is determined as a first playback axis, and a modulus of an angular velocity of rotation of the gyroscope about the X axis may be acquired as data magnitude of the angular velocity data. If the component corresponding to the Y axis is greater than the component corresponding to the X axis, the playback axis is determined as the second playback axis, and a modulus of an angular velocity of rotation of the gyroscope about the Y axis may be acquired as the data magnitude of the angular velocity data.
Operation 631: Determine a coordinate point switching speed between at least two coordinate points in a dynamic playback coordinate system based on an operation speed of the motion control operation.

In some examples, the operation speed of the motion control operation is in a positive correlation with the coordinate point switching speed between the at least two coordinate points. That is, a higher speed at which the user performs the motion control operation indicates a corresponding higher switching speed between coordinate points. Otherwise, if the operation speed is low, the switching speed between the coordinate points is slowed.
Operation 632: Determine, based on a motion direction of the motion control operation, an axial direction when the at least two coordinate points are switched in the dynamic playback coordinate system.

In some examples, in a case that the motion direction of the motion control operation meets a first direction requirement, the corresponding axial direction when the at least two coordinate points are switched on a first playback axis is determined as the first axial direction; in a case that the motion direction of the motion control operation meets a second direction requirement, the corresponding axial direction when the at least two coordinate points are switched on the first playback axis is determined as the second axial direction; in a case that the motion direction of the motion control operation meets a third direction requirement, the corresponding axial direction when the at least two coordinate points are switched on the second playback axis is determined as the third axial direction; and in a case that the motion direction of the motion control operation meets a fourth direction requirement, the corresponding axial direction when the at least two coordinate points are switched on a second playback axis is determined as the fourth axial direction.

For example, if a component corresponding to the X axis is greater than a component corresponding to the Y axis, the playback axis is determined as the first playback axis. If a rotation direction of the X axis is anticlockwise, the motion direction is the first direction. If the first direction requirement is met, the axial direction is the first axial direction. If the rotation direction of the X axis is clockwise, the motion direction is the second direction. If the second direction requirement is met, the axial direction is the second axial direction. If a component corresponding to the Y axis is greater than a component corresponding to the X axis, the playback axis is determined as the second playback axis. If a rotation direction of the Y axis is anticlockwise, the motion direction is the third direction. If the third direction requirement is met, the axial direction is the third axial direction. If a rotation direction of the Y axis is clockwise, the motion direction is the fourth direction. If the fourth direction requirement is met, the axial direction is the fourth axial direction.

In the foregoing examples, the coordinate point switching speed is determined based on the operation speed of the motion control operation, and then the user can accurately control a progress and a rhythm of the dynamic playback. In addition, a switching axial direction is determined based on the motion direction of the motion control operation, to further enhance a capability of the user to control a dynamic content playback process.
Operation 633: Perform coordinate point switching between the at least two coordinate points in the dynamic playback coordinate system based on the coordinate point switching speed and the axial direction; and sequentially display, in response to the coordinate point switching, images respectively corresponding to the at least two coordinate points.

For example, switching is performed between the at least two coordinate points in the dynamic playback coordinate system based on the coordinate point switching speed and the axial direction that are determined previously, and the images corresponding to the coordinate points are sequentially displayed along with the coordinate point switching, to form an animation.

In conclusion, according to the method for displaying dynamic content provided in this example of this application, dynamic content including at least two images is displayed in the terminal device. The at least two images are images distributed in the dynamic playback coordinate system. When a user controls the terminal device to move, display is switched between the at least two images in the dynamic playback coordinate system in response to a user operation, to form an animation in which the dynamic content changes along with motion of the terminal. In an aspect, the user may customize the design of the at least two images based on a requirement. Compared with a single image layer offset animation formed by an image layer offset, the animation formed by switching display between the at least two images is richer, and diversity of the animation formed by controlling the terminal device to move is enriched. In another aspect, the images are distributed in the dynamic playback coordinate system, the user may perform interaction and control in multiple dimensions. This multi-dimensional interaction manner provides richer operation selection and a finer control capability for the user, to further enrich an animation formed by switching display between the at least two images. In yet another aspect, because a dynamic visual effect of the dynamic content is implemented by switching display between at least two images, the terminal device can implement dynamic and diversified dynamic content by using only the at least two images provided in advance. In a process of presenting the dynamic content, consumption of computational resources of the terminal device is relatively small, and computational load on a device processor is relatively low. This enables the terminal device to operate at relatively low power consumption when rendering the dynamic content, and prolongs battery duration of the terminal device.

In this example of this application, switching display between coordinate points in the dynamic playback coordinate system is controlled based on the operation speed and the motion direction of the motion control operation. When display is switched between image content at different coordinate points, a dynamic effect trend (for example, a dynamic change speed and a dynamic change direction) of the image content can match the motion of the terminal device, to ensure matching between the dynamic effect and the terminal device in terms of visual effect, and improve a display effect of the dynamic content.

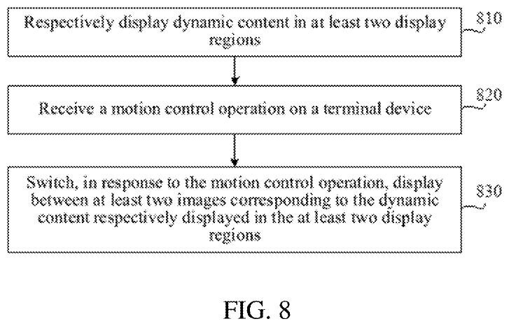

In some examples, the terminal device includes at least two display regions. For example, as shown in FIG. 8, the example shown in FIG. 3 may alternatively be implemented as the following operation 810 to operation 830.
Operation 810: Respectively display dynamic content in at least two display regions.

In some examples, types of the dynamic content include an animation, a video, an animated image, and the like. For example, the dynamic content may be character introduction content, dynamic wallpaper, a lock screen animation, a song cover, and the like. This is not limited herein.

Each piece of dynamic content includes at least two images, and the at least two images are configured for representing dynamic representation of the dynamic content.

In some examples, different display regions display different dynamic content. For example, dynamic content a is displayed on a left-side screen of the terminal device, and dynamic content b is displayed on a right-side screen of the terminal device.
Operation 820: Receive a motion control operation on a terminal device.

In some examples, the terminal device includes mobile devices such as a mobile phone, a tablet computer, and a wearable device. In some examples, the motion control operation on the terminal device includes moving the terminal device, rotating the terminal device, and the like. This is not limited herein.

In some examples, the terminal device includes an angular velocity sensor, and the angular velocity sensor can measure rates and directions of rotation of the terminal device about a plurality of axes (generally, X, Y, and Z axes). The angular velocity sensor may be implemented as a gyroscope.
Operation 830: Switch, in response to the motion control operation, display between at least two images corresponding to the dynamic content respectively displayed in the at least two display regions.

In some examples, different animations are simultaneously displayed in at least two display regions based on an operation speed of the motion control operation and a motion direction of the motion control operation. For example, when the user controls the terminal device to rotate, both dynamic content a and dynamic content b are displayed in the form of animations in response to the motion control operation.

In some examples, the at least two display regions include a first display region and a second display region, the first display region displays first dynamic content, and the second display region displays second dynamic content.

In some examples, in response to the motion control operation, display is switched between the at least two images corresponding to the first dynamic content displayed in the first display region, to form a first animation in which the first dynamic content changes in response to the motion control operation; and display is switched between the at least two images corresponding to the second dynamic content displayed in the second display region, to form a second animation in which the second dynamic content changes in response to the motion control operation.

In some examples, in a case that the first animation matches the second animation, the first animation is merged with the second animation, and a merged animation is displayed.

For example, a current display interface of the terminal device may be implemented as a playback interface of a dynamic advertisement. A falling animation corresponding to a recommended article is displayed in a top region of the terminal device, and a moving animation of a virtual character is displayed in a bottom region of the terminal device. A user controls the terminal device to rotate leftwards, the bottom region displays leftward movement of the virtual character, and the top region displays lower left falling of the recommended article. In an operation process of the motion control operation, when a vertical line at which a falling point of the recommended article in the top region is located is within a range corresponding to a location point at which the virtual character is located in the bottom region, it is determined that the falling animation matches the moving animation. In this case, a pop-up window is displayed in the terminal device. A merged animation of the falling animation and the moving animation is displayed in the pop-up window. For example, when virtual clothes or accessories are displayed, the virtual clothes or accessories “fly onto” the virtual character in a form of an animation, to simulate a try-on effect. Subsequently, the merged animation may alternatively be changed in response to the motion control operation, for example, viewing front and back wearing effects of the virtual clothes.

In conclusion, according to the method for displaying dynamic content provided in this example of this application, a plurality of pieces of dynamic content is displayed in the terminal device. When a user controls the terminal device to move, the plurality of pieces of dynamic content respectively changes in response to the user operation. In an aspect, the user may customize the design of the at least two images based on a requirement. Compared with a single image layer offset animation formed by an image layer offset, the dynamic content formed by switching display between the at least two images is richer, and diversity of the dynamic content formed by controlling the terminal device to move is enriched. In another aspect, the user not only can experience a dynamic change triggered by the motion of the terminal device, but also can implement interaction and switching among a plurality of pieces of dynamic content, to enjoy more an immersive and interactive animation experience. In yet another aspect, because a dynamic visual effect of the dynamic content is implemented by switching display between at least two images, the terminal device can implement dynamic and diversified dynamic content by using only the at least two images provided in advance. In a process of presenting the dynamic content, consumption of computational resources of the terminal device is relatively small, and computational load on a device processor is relatively low. This enables the terminal device to operate at relatively low power consumption when rendering the dynamic content, and prolongs battery duration of the terminal device.

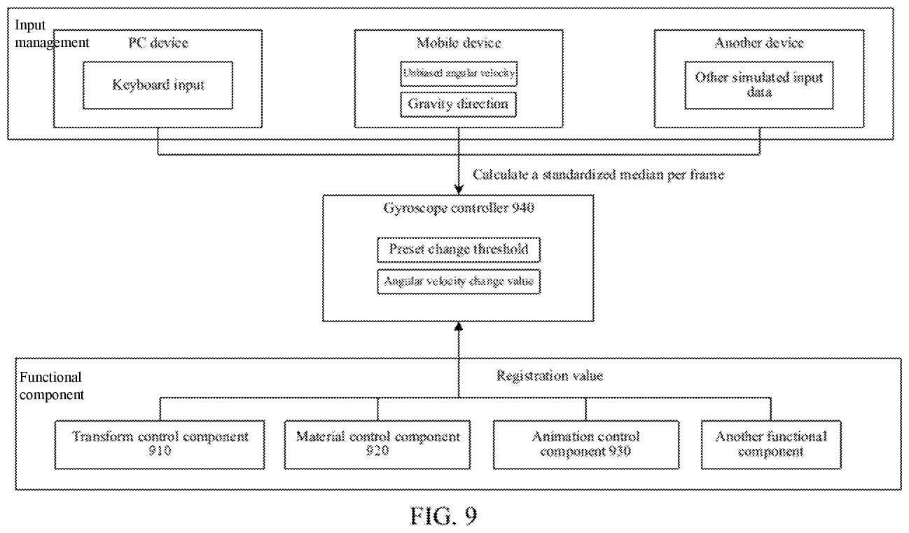

A functional framework of a gyroscope provided in this application is described below by using an example in which the angular velocity sensor is implemented as the gyroscope. For example, referring to FIG. 9, before the method for displaying dynamic content according to this example of this application is performed, a plurality of functional components associated with the gyroscope may be manufactured. The plurality of functional components include: a transform control component 910, a material control component 920, an animation control component 930, and another functional component. The functional component includes a user-defined parameter, and manufacturing the functional component refers to binding the gyroscope to the user-defined parameter of the functional component. In this way, a value of the user-defined parameter can change based on a change of a collection value of the gyroscope.

The transform control component 910 is a component configured to control a location, rotation, and zoom of a display element (for example, a virtual character, a flower, and an ink wash special effect) in an animation. Each display element has a transform component. Rotation of a display element a is used as an example. A collection value of the gyroscope is acquired, the collection value of the gyroscope is mapped to a rotation parameter a based on a preset mapping relationship 1, and the rotation parameter a is applied to a rotation parameter of a transform control component of the display element a, to control rotation of the display element a by using the gyroscope.

The material control component 920 is configured to control an appearance change of the display element in the animation, including a change of a color, reflectivity, transparency, coarseness, and the like. Each display element has a material control component. The transparency of a display element b is used as an example. A collection value of the gyroscope is acquired, the collection value of the gyroscope is mapped to transparency b based on a preset mapping relationship 2, and the transparency b is applied to a transparency parameter of a material control component of the display element b, to control the transparency of the display element b by using the gyroscope.

The animation control component 930 is configured to control switching display between at least two image frames in the animation, that is, control a playback effect of the animation. An animation corresponding to a virtual character c in the at least two image frames is used as an example. For example, the at least two image frames are configured for representing an animation of the virtual character c from sitting to standing. A collection value of the gyroscope is acquired. The collection value of the gyroscope is mapped to a playback parameter c based on a preset mapping relationship 3. The playback parameter includes a playback speed and a playback direction. The playback parameter c is applied to the playback parameter of the virtual character c in the animation control component, to control a playback effect of an animation of the virtual character c from sitting to standing by using the gyroscope. The method for displaying dynamic content provided in this application is mainly implemented by using the animation control component 930.

During playing the animation, in the same image frame, collection values of gyroscopes used by a plurality of functional components are the same. As shown in FIG. 9, for each image frame in the animation, a standardized median of the gyroscope is determined as a collection value, and standardized medians of at least two image frames corresponding to the animation are stored to a gyroscope controller 940. For example, assuming that a standardized median of a gyroscope of an image frame a is determined as a standard value x, the standard value x can be acquired from the gyroscope controller 940 when the functional component is registered, to determine a user-defined parameter corresponding to the image frame a in each functional component based on the standard value x.

For a mobile device, original data of each frame is acquired from the gyroscope, where the original data includes angular velocities on X, Y, and Z axes; then an unbiased angular velocity perpendicular to a gravity direction is calculated based on the original data; and finally, angular velocity change values of a current frame and a previous frame in directions of the X axis, the Y axis, and the Z axis are calculated based on the unbiased angular velocity, and the angular velocity change values are used as standardized medians that represent a motion state of the current frame relative to the previous frame. In some examples, the gyroscope controller 940 further stores a preset change threshold. When the angular velocity change value between the current frame and the previous frame is greater than the preset change threshold, it is determined that there is a change in a picture in the current frame compared with the previous frame, and update of the user-defined parameter is triggered.

In some examples, when the functional component is tested and debugged, input data of a personal computer (PC) device may further be acquired to simulate input data of a gyroscope, or other simulated input data of another device may be acquired to simulate the input data of the gyroscope. A standardized median of the gyroscope is calculated based on the simulated input data of the gyroscope, to perform testing, debugging, and the like on the functional component.

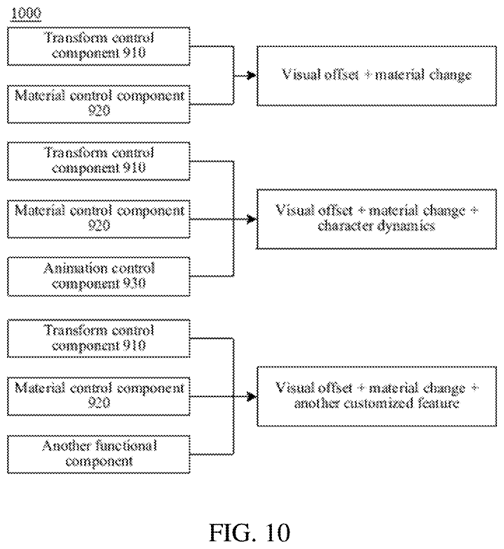

In some examples, after the functional components are manufactured, different animations can be implemented by using different combinations of the functional components. For example, as shown in FIG. 10, in an example 1000, an animation of visual offset+material change can be implemented by using a transform control component 910 and a material control component 920, an animation of visual offset+material change+character dynamics can be implemented by using the transform control component 910, the material control component 920, and an animation control component 930, and an animation of visual offset+material change+another customized feature can be implemented by using the transform control component 910, the material control component 920, and another functional component. This is not limited herein.

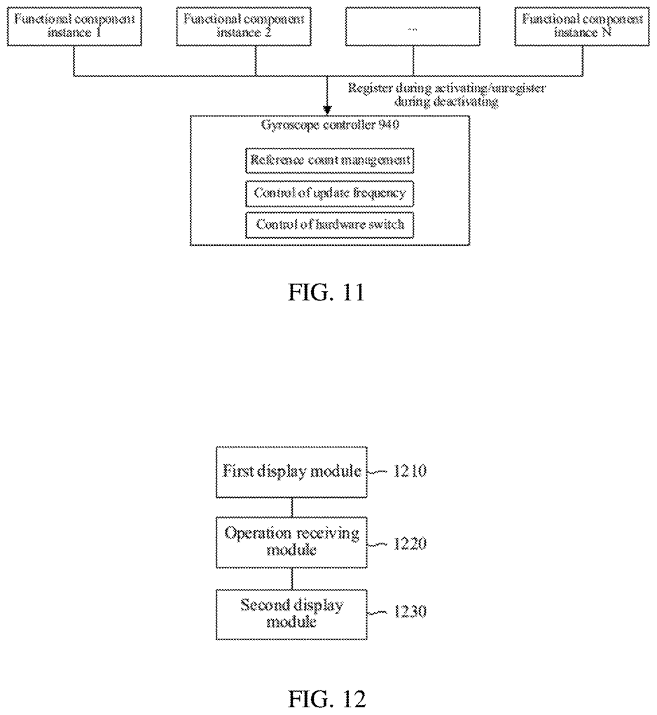

In some examples, because there is a significant performance overhead in starting a gyroscope on the terminal device, a time for activating a gyroscope function needs to be minimized. In some examples, the gyroscope controller 940 manages a currently activated functional component instance. For example, referring to FIG. 11, the gyroscope controller 940 includes three functions, that is, reference count management, control of an update frequency, and control of a hardware switch.

For the reference count management function and the hardware switch control function, when each functional component using a gyroscope is presented, the gyroscope is registered and used, and when the functional component using the gyroscope is hidden or destroyed, the gyroscope is unregistered. The gyroscope controller 940 performs reference counting based on registration/unregistration of the functional component. When a registration count is greater than 0, a gyroscope switch of a mobile device is activated, and when the registration count is equal to 0, the gyroscope switch of the mobile device is deactivated, to minimize time for activating the gyroscope.

For the function of controlling an update frequency, there is overhead for updating a functional component (for example, updating a material parameter). The gyroscope controller may control an update frequency of each functional component. For example, it may be set that the functional component is updated once every 2 frames/3 frames.

For example, FIG. 12 is a structural block diagram of a dynamic content display apparatus. As shown in FIG. 12, the apparatus includes:
a first display module 1210, configured to display the dynamic content, the dynamic content including at least two images;
an operation receiving module 1220, configured to receive a motion control operation on a terminal device; and
a second display module 1230, configured to switch display between the at least two images in response to the motion control operation, switching between the at least two images representing that the dynamic content changes in response to the motion control operation.

In some examples, the at least two images include images distributed on a dynamic playback axis, and different images correspond to different location points on the dynamic playback axis. The second display module 1230 is configured to: perform location point switching between at least two location points on the dynamic playback axis based on the motion control operation; and sequentially display, in response to the location point switching, images respectively corresponding to the at least two location points.

In some examples, the second display module 1230 is configured to: determine a location point switching speed between the at least two location points on the dynamic playback axis based on an operation speed of the motion control operation; determine, based on a motion direction of the motion control operation, a corresponding axial direction when the at least two location points are switched on the dynamic playback axis; and perform location point switching between the at least two location points on the dynamic playback axis based on the location point switching speed and the axial direction.

In some examples, the dynamic playback axis correspondingly has a first axial direction and a second axial direction, and the first axial direction is opposite to the second axial direction. The second display module 1230 is configured to: determine, in a case that the motion direction of the motion control operation meets a first direction requirement, the corresponding axial direction when the at least two location points are switched on the dynamic playback axis as the first axial direction; and determine, in a case that the motion direction of the motion control operation meets a second direction requirement, the corresponding axial direction when the at least two location points are switched on the dynamic playback axis as the second axial direction.

In some examples, the second display module 1230 is configured to: acquire angular velocity data corresponding to the motion control operation, the angular velocity data being configured for indicating an angular velocity that is generated relative to a reference plane when the terminal device is controlled to move via the motion control operation; determine an operation speed of the motion control operation based on data magnitude of the angular velocity data; and determine the motion direction of the motion control operation based on a vector direction of the angular velocity data.

In some examples, the dynamic playback axis includes a plurality of axis segments. The second display module 1230 is configured to: acquire, in a case that the motion direction of the motion control operation matches an i^{th} axis segment, speed mapping data of the i^{th} axis segment, the speed mapping data being configured for indicating a mapping relationship between the operation speed and the location point switching speed, and i being a positive integer; and map the operation speed based on the speed mapping data, to obtain an i^{th} location point switching speed between at least two location points on the i^{th} axis segment.

In some examples, the at least two images include images distributed in a dynamic playback coordinate system, and different images correspond to different coordinate points in the dynamic playback coordinate system. The second display module 1230 is configured to: perform coordinate point switching between at least two coordinate points in the dynamic playback coordinate system based on the motion control operation; and sequentially display, in response to the coordinate point switching, images respectively corresponding to the at least two coordinate points.

In some examples, the dynamic playback coordinate system includes a first playback axis and a second playback axis, the first playback axis corresponds to a first axial direction and a second axial direction, the first axial direction is opposite to the second axial direction, the second playback axis corresponds to a third axial direction and a fourth axial direction, and the third axial direction is opposite to the fourth axial direction. The second display module 1230 is configured to: determine a coordinate point switching speed between the at least two coordinate points in the dynamic playback coordinate system based on the operation speed of the motion control operation; determine, based on the motion direction of the motion control operation, an axial direction when the at least two coordinate points are switched in the dynamic playback coordinate system; and perform coordinate point switching between the at least two coordinate points in the dynamic playback coordinate system based on the coordinate point switching speed and the axial direction.

In some examples, the image includes image layers respectively corresponding to m elements, the dynamic content includes m pieces of sub-dynamic content, a j^{th} piece of sub-dynamic content indicates a change process of a j^{th} piece of display element, m is an integer greater than 1, j≤m, and j is a positive integer. The second display module 1230 is configured to: switch display between the at least two images in response to the motion control operation, switching between the at least two j^{th} image layers representing that the j^{th} piece of sub-dynamic content changes in response to the motion control operation.

In some examples, the terminal device includes an angular velocity sensor. The second display module 1230 is configured to: acquire angular velocity data collected by the angular velocity sensor; and switch, based on the angular velocity data, display between the at least two images in response to the motion control operation.

In some examples, the second display module 1230 is configured to: activate the angular velocity sensor in a case that an animation mode of the dynamic content is in an enabled state; and deactivate the angular velocity sensor in a case that an animation mode of the dynamic content is in a hidden state or a disabled state.

In some examples, the second display module 1230 is configured to: receive a trajectory drawing operation, the trajectory drawing operation being configured for controlling the terminal device to move to form a first motion trajectory; and determine, in a case that the first motion trajectory meets a preset trajectory requirement, that the animation mode of the dynamic content is in the enabled state, and activate the angular velocity sensor.

In some examples, the terminal device is connected to a game controller device. The operation receiving module 1220 is configured to receive a motion control operation on the game controller device as the motion control operation on the terminal device.

In some examples, the first display module 1210 is configured to display progress information corresponding to the dynamic content, the progress information indicating a playback progress of the dynamic content. The second display module 1230 is configured to update, in response to the motion control operation, the progress information based on a currently displayed image.

In some examples, the terminal device includes at least two display regions. The first display module 1210 is configured to respectively display dynamic content in at least two display regions. The second display module 1230 is configured to switch, in response to the motion control operation, display between at least two images corresponding to the dynamic content respectively displayed in the at least two display regions.

In conclusion, according to the apparatus for displaying dynamic content provided in this example of this application, dynamic content including at least two images is displayed in the terminal device. When a user controls the terminal device to move, display is switched between the at least two images in response to a user operation, to form an animation in which the dynamic content changes along with the motion of the terminal device. In an aspect, the user may customize the design of the at least two images based on a requirement. Compared with a single image layer offset animation formed by an image layer offset, the dynamic content formed by switching display between the at least two images is richer, and diversity of the dynamic content formed by controlling the terminal device to move is enriched. In another aspect, the user can control a display progress of the dynamic content displayed by the terminal device through user movements, to enhance interactivity between the user and the dynamic content, and improve human-computer interaction efficiency. In yet another aspect, because a dynamic visual effect of the dynamic content is implemented by switching display between at least two images, the terminal device can implement dynamic and diversified dynamic content by using only the at least two images provided in advance. In a process of presenting the dynamic content, consumption of computational resources of the terminal device is relatively small, and computational load on a device processor is relatively low. This enables the terminal device to operate at relatively low power consumption when rendering the dynamic content, and prolongs battery duration of the terminal device.

The apparatus for displaying dynamic content provided in the foregoing examples is illustrated only with an example of division of the foregoing functional modules. In practical application, the foregoing functions may be assigned to and completed by different functional modules as needed. That is, an internal structure of a device is divided into different functional modules to complete all or some of the functions described above. In addition, the apparatus for displaying dynamic content provided in the foregoing examples and the method for displaying dynamic content belong to the same concept. For details of a specific implementation process, refer to the method examples. Details are not described herein again.

In this application, before player-related data is collected and during collection of the player-related data, a prompt interface or a pop-up window can be displayed, or voice prompt information can be outputted. The prompt interface, the pop-up window, or the voice prompt information is configured for prompting the player that player-related data is currently being collected. In this way, in this application, related operations of obtaining the player-related data start to be performed only after a confirmation operation of the player on the prompt interface or the pop-up window is obtained. Otherwise (that is, when no confirmation operation of the player on the prompt interface or the pop-up window is obtained), the related operations of obtaining the player-related data are ended, that is, the player-related data is not to be acquired. In other words, in this application, all acquired player data are collected with the consent and authorization of players. The collection, use, and processing of relevant player data need to comply with relevant laws, regulations, and standards.

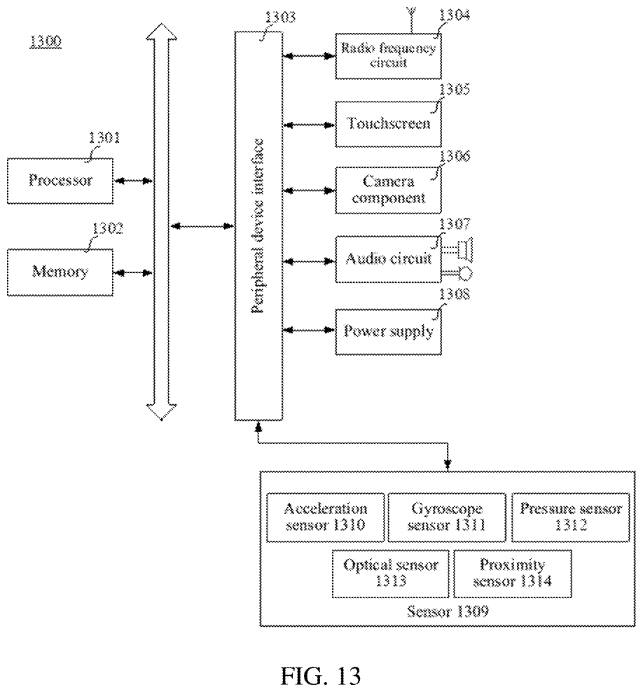

FIG. 13 is a structural block diagram of a computer device according to an example of this application.

A computer device 1300 may be a portable mobile terminal, for example, a smartphone, a tablet computer, a moving picture experts group audio layer III (MP3) player, or a moving picture experts group audio layer IV (MP4) player. The computer device 1300 may alternatively be referred to as another name such as a player device and a portable terminal.

Generally, the computer device 1300 includes a processor 1301 and a memory 1302.

The processor 1301 may include one or more processing cores, for example, a 4-core processor or a 13-core processor. The processor 1301 may alternatively include a main processor and a co-processor. In some examples, the processor 1301 may be integrated with a graphics processing unit (GPU). The GPU is configured to render and draw content that needs to be displayed on a display screen. In some examples, the processor 1301 may further include an artificial intelligence (AI) processor. The AI processor is configured to process computing operations related to machine learning.

The memory 1302 may include one or more computer-readable storage media. The computer-readable storage media may be tangible and non-transitory. In some examples, the non-transitory computer-readable storage medium in the memory 1302 is configured to store at least one instruction, and the at least one instruction is configured to be executed by the processor 1301 to implement the method for display dynamic content provided in this example of this application.

In some examples, the computer device 1300 may alternatively include: a peripheral device interface 1303 and at least one peripheral device. Specifically, the peripheral device includes: at least one of a radio frequency circuit 1304, a touch display screen 1305, a camera 1306, an audio circuit 1307, and a power supply 1308.

The peripheral interface 1303 may be configured to connect the at least one peripheral related to input/output (I/O) to the processor 1301 and the memory 1302. In some examples, the processor 1301, the memory 1302, and the peripheral device interface 1303 are integrated on the same chip or circuit board. In some other examples, any or two of the processor 1301, the memory 1302, and the peripheral device interface 1303 may be implemented on an independent chip or circuit board. This is not limited in the examples.

A radio frequency (RF) circuit 1304 is configured to receive and transmit an RF signal that is alternatively referred to as an electromagnetic signal. The touchscreen 1305 is configured to display a user interface (UI). The camera component 1306 is configured to collect images or videos. The audio circuit 1307 is configured to provide an audio interface between a player and the computer device 1300. The power supply 1308 is configured to supply power to components in the computer device 1300.

In some examples, the computer device 1300 further includes one or more sensors 1309. The one or more sensors 1309 include, but are not limited to: an acceleration sensor 1310, a gyroscope sensor 1311, a pressure sensor 1312, an optical sensor 1313, and a proximity sensor 1314.

The acceleration sensor 1310 may detect magnitude of acceleration on three coordinate axes of a coordinate system established with the computer device 1300. The gyroscope sensor 1311 may detect a body direction and a rotation angle of the computer device 1300. The gyroscope sensor 1311 may cooperate with the acceleration sensor 1310 to collect a three-dimensional (3D) action of the player on the computer device 1300. The pressure sensor 1312 may be disposed on a side frame of the computer device 1300 and/or a lower layer of the touchscreen 1305. The optical sensor 1313 is configured to collect ambient light intensity. The proximity sensor 1314, alternatively referred to as a range sensor, is generally disposed on a front surface of the computer device 1300.

A person skilled in the art may understand that the structure shown in FIG. 13 does not constitute a limitation to the computer device 1300, more components or fewer components than those shown in the figure may be included, or some components may be combined, or a different component deployment may be used.

In an example, this application provides a chip. The chip includes a programmable logic circuit and/or program instructions. The chip is configured to, when running on a computer device, implement the method for displaying dynamic content according to the foregoing method examples.

This application provides a computer-readable storage medium. The computer-readable storage medium has a computer program stored thereon, and the computer program is loaded and executed by a processor to implement the method for displaying dynamic content according to the foregoing method examples.

This application provides a computer program product or a computer program, the computer program product or the computer program including computer instructions, the computer instructions being stored in a computer-readable storage medium. A processor of a computer device reads the computer instructions from the computer-readable storage medium, and executes the computer instructions, to enable the processor of the computer device to load and execute the method for display dynamic content according to the foregoing method examples.

Numbers in the foregoing examples of this application are merely for description, but do not represent superiority or inferiority of the examples.

A person of ordinary skill in the art may understand that all or some steps of the foregoing examples may be implemented by hardware, or may be implemented by a program instructing relevant hardware. The program may be stored in a computer-readable storage medium. The computer-readable storage medium mentioned above may be a read-only memory, a magnetic disc, an optical disc, or the like.

A person skilled in the art is to aware that in the one or more examples, the functions described in the examples of this application may be implemented by using hardware, software, firmware, or any combination thereof. When software is used for implementation, the previously described functions can be stored in a computer-readable medium or transmitted as one or more instructions or code in the computer-readable medium. The computer-readable medium includes a computer storage medium and a communication medium. The communication medium includes any medium that enables a computer program to be transmitted from one place to another. The storage medium may be any available medium accessible to a general-purpose or dedicated computer.

What is claimed is:

1. A method, performed by a terminal device, comprising:
displaying dynamic content comprising at least two images;
receiving a motion control operation on the terminal device; and
switching display between the at least two images in response to the motion control operation, forming an animation in which the dynamic content changes.

2. The method according to claim 1, wherein the at least two images comprise images distributed on a dynamic playback axis, and different images correspond to different location points on the dynamic playback axis; and
the switching display between the at least two images in response to the motion control operation comprises:
performing location point switching between at least two location points on the dynamic playback axis based on the motion control operation; and
sequentially displaying, in response to the location point switching, the images respectively corresponding to the at least two location points.

3. The method according to claim 2, wherein the performing location point switching between at least two location points on the dynamic playback axis based on the motion control operation comprises:
determining a location point switching speed between the at least two location points on the dynamic playback axis based on an operation speed of the motion control operation;
determining, based on a motion direction of the motion control operation, a corresponding axial direction when the at least two location points are switched on the dynamic playback axis; and
performing location point switching between the at least two location points on the dynamic playback axis based on the location point switching speed and the axial direction.

4. The method according to claim 3, wherein the dynamic playback axis comprises a first axial direction and a second axial direction, and the first axial direction is opposite to the second axial direction; and
the determining, based on the motion direction of the motion control operation, the corresponding axial direction when the at least two location points are switched on the dynamic playback axis comprises:
determining, based on determining that the motion direction of the motion control operation meets a first direction requirement, the corresponding axial direction when the at least two location points are switched on the dynamic playback axis as the first axial direction; and
determining, based on determining that the motion direction of the motion control operation meets a second direction requirement, the corresponding axial direction when the at least two location points are switched on the dynamic playback axis as the second axial direction.

5. The method according to claim 3, further comprising:
acquiring angular velocity data corresponding to the motion control operation, wherein the angular velocity data indicates an angular velocity that is generated relative to a reference plane;
before the determining the location point switching speed between the at least two location points on the dynamic playback axis, the method further comprises:
determining an operation speed of the motion control operation based on data magnitude of the angular velocity data; and
before the determining the corresponding axial direction when the at least two location points are switched on the dynamic playback axis, the method further comprises:
determining the motion direction of the motion control operation based on a vector direction of the angular velocity data.

6. The method according to claim 5, wherein the dynamic playback axis comprises a plurality of axis segments; and
the determining the location point switching speed between the at least two location points on the dynamic playback axis comprises:
acquiring, based on determining that the motion direction of the motion control operation matches an i^{th} axis segment, speed mapping data of the i^{th} axis segment, wherein the speed mapping data indicates a mapping relationship between the operation speed and the location point switching speed, and i is a positive integer; and
mapping the operation speed based on the speed mapping data, to obtain an i^{th} location point switching speed between at least two location points on the i^{th} axis segment.

7. The method according to claim 1, wherein the at least two images comprise images distributed in a dynamic playback coordinate system, and different images correspond to different coordinate points in the dynamic playback coordinate system; and
the switching display between the at least two images in response to the motion control operation comprises:
performing coordinate point switching between at least two coordinate points in the dynamic playback coordinate system based on the motion control operation; and
sequentially displaying, in response to the coordinate point switching, images respectively corresponding to the at least two coordinate points.

8. The method according to claim 7, wherein the dynamic playback coordinate system comprises a first playback axis and a second playback axis, the first playback axis corresponds to a first axial direction and a second axial direction, the first axial direction is opposite to the second axial direction, the second playback axis corresponds to a third axial direction and a fourth axial direction, and the third axial direction is opposite to the fourth axial direction; and
the performing coordinate point switching between at least two coordinate points in the dynamic playback coordinate system comprises:
determining a coordinate point switching speed between the at least two coordinate points in the dynamic playback coordinate system based on the operation speed of the motion control operation;
determining, based on the motion direction of the motion control operation, an axial direction when the at least two coordinate points are switched in the dynamic playback coordinate system; and
performing coordinate point switching between the at least two coordinate points in the dynamic playback coordinate system based on the coordinate point switching speed and the axial direction.

9. The method according to claim 1, wherein the image comprises image layers respectively corresponding to m elements, the dynamic content comprises m pieces of sub-dynamic content, a j^{th} piece of sub-dynamic content indicates a change process of a j^{th} piece of display element, m is an integer greater than 1, j≤m, and j is a positive integer; and
the switching display between the at least two images in response to the motion control operation comprises:
switching display between the at least two images in response to the motion control operation, switching between the at least two j^{th} image layers representing that the j^{th} piece of sub-dynamic content changes in response to the motion control operation.

10. The method according to claim 1, wherein the terminal device comprises an angular velocity sensor; and
the switching display between the at least two images in response to the motion control operation comprises:
acquiring angular velocity data collected by the angular velocity sensor; and
switching, based on the angular velocity data, display between the at least two images in response to the motion control operation.

11. The method according to claim 10, further comprising:
activating the angular velocity sensor based on determining that an animation mode of the dynamic content is in an enabled state; and
deactivating the angular velocity sensor based on determining that an animation mode of the dynamic content is in a hidden state or a disabled state.

12. The method according to claim 11, wherein the activating the angular velocity sensor comprises:
receiving a trajectory drawing operation, wherein the trajectory drawing operation is configured to control the terminal device to move to form a first motion trajectory;
determining, based on determining that the first motion trajectory meets a preset trajectory requirement, that the animation mode of the dynamic content is in the enabled state; and
activating the angular velocity sensor.

13. The method according to claim 1, wherein the terminal device is connected to a game controller device; and
the receiving the motion control operation on the terminal device comprises:
receiving the motion control operation on the game controller device.

14. The method according to claim 1, further comprising:
displaying progress information corresponding to the dynamic content, the progress information indicating a playback progress of the dynamic content; and
updating, in response to the motion control operation, the progress information based on a currently displayed image.

15. The method according to claim 1, wherein the terminal device comprises at least two display regions;
the displaying the dynamic content comprises: respectively displaying the dynamic content in the at least two display regions; and
the switching display between the at least two images in response to the motion control operation comprises: switching, in response to the motion control operation, display between at least two images corresponding to the dynamic content respectively displayed in the at least two display regions.

16. A mobile device, comprising:
one or more processors; and
memory storing instructions that, when executed by the one or more processors, cause the mobile device to:
display dynamic content comprising at least two images;
receive a motion control operation on the mobile device; and
switch display between the at least two images in response to the motion control operation, forming an animation in which the dynamic content changes.

17. The mobile device according to claim 16, wherein the at least two images comprise images distributed on a dynamic playback axis, and different images correspond to different location points on the dynamic playback axis; and
the instructions, when executed by the one or more processors, cause the mobile device to switch display between the at least two images in response to the motion control operation by:
performing location point switching between at least two location points on the dynamic playback axis based on the motion control operation; and
sequentially displaying, in response to the location point switching, the images respectively corresponding to the at least two location points.

18. The mobile device according to claim 16, further comprising:
an angular velocity sensor, wherein the instructions, when executed by the one or more processors, cause the mobile device to switch display between the at least two images in response to the motion control operation by:
acquiring angular velocity data collected by the angular velocity sensor; and
switching, based on the angular velocity data, display between the at least two images in response to the motion control operation.

19. The mobile device according to claim 16, wherein the instructions, when executed by the one or more processors, cause the mobile device to:
display progress information corresponding to the dynamic content, the progress information indicating a playback progress of the dynamic content; and
update, in response to the motion control operation, the progress information based on a currently displayed image.

20. A non-transitory computer-readable medium storing instructions that, when executed, cause:
displaying, on a terminal device, dynamic content comprising at least two images;
receiving a motion control operation on the terminal device; and
switching display between the at least two images in response to the motion control operation, forming an animation in which the dynamic content changes.
